(19) United States
(12) Patent Application Publication
(10) Pub. No.: US 2013/0025323 A1
(43) Pub. Date: Jan. 31, 2013

(54) FIBER-BASED GASKET, GLASS MANUFACTURING SYSTEM, AND METHOD FOR REDUCING THERMAL CELL INDUCED BLISTERS

(71) Applicants: David M. Lineman, Painted Post, NY (US); Matthew C. Morse, Campbell, NY (US)

(72) Inventors: David M. Lineman, Painted Post, NY (US); Matthew C. Morse, Campbell, NY (US)

(21) Appl. No.: 13/189,932

(22) Filed: Jul. 25, 2011

(51) Int. Cl. C03B 5/167; F16J 15/02

(52) U.S. Cl. 65/171; 277/650; 277/312

(57) ABSTRACT

A fiber-based gasket, a glass manufacturing system, and a method are described herein for reducing thermal cell induced blisters. In one embodiment, the fiber-based gasket is placed in a connection between a first glass manufacturing device (e.g., capsule surrounding a downcomer) and a second glass manufacturing device (e.g., fusion draw machine surrounding an inlet). The fiber-based gasket has a density and compression which results in a gas permeation rate per unit surface area that is less than 22.5 ml/min/cm² to reduce thermal cell induced blistering within the first glass manufacturing device and the second glass manufacturing device.

### TECHNICAL FIELD

The present invention relates to a fiber-based gasket, a glass manufacturing system, and a method for reducing thermal cell induced blisters. In one embodiment, the fiber-based gasket is placed in a connection between a first glass manufacturing device (e.g., capsule surrounding a downcomer) and a second glass manufacturing device (e.g., fusion draw machine surrounding an inlet).

### BACKGROUND

Flat panel display devices such as Liquid Crystal Displays (LCDs) utilize flat glass sheets. A preferred technique for manufacturing flat glass sheets is a fusion process (e.g., downdraw process) which is described in U.S. Pat. Nos. 3,338,696 and 3,682,609 (the contents of which are incorporated by reference herein). In the fusion process, the flat glass sheets are made by using vessels that contain precious metals, e.g. platinum or platinum alloys. The precious metals are generally considered to be inert in relation to most glasses, and thus should not cause defects in the glass sheets. However, this is not necessarily true since the use of precious metals can still cause defects in the glass sheets. For instance, the glass manufacturing system which utilizes the fusion process currently suffers from unacceptable levels of loss due to thermal cell induced blisters which are caused by the infiltration of ambient air between the connections of glass manufacturing devices. This problem is particularly noticeable in the glass manufacturing system which utilizes the fusion process to produce larger glass sheets (e.g., 2.2 meters by 2.5 meters (Gen 8 size glass) or larger glass sheets). Thus, there is a need to enhance the glass manufacturing system to address this shortcoming and other shortcomings to produce quality glass sheets.

### SUMMARY

A fiber-based gasket, a glass manufacturing system, and a method which address the aforementioned shortcomings of the prior art are described in the independent claims of the present application. Advantageous embodiments of the fiber-based gasket, the glass manufacturing system, and the method for reducing thermal cell induced blisters are described in the dependent claims.

In one aspect, the present invention provides a fiber-based gasket placed in a connection between a first glass manufacturing device and a second glass manufacturing device. The fiber-based gasket comprises a fiber-based material having a density and compression which results in a gas permeation rate per unit surface area that is less than 22.5 ml/min/cm² where the surface area is based on an inner gasket surface area. The fiber-based material reduces thermal cell induced blistering within the first glass manufacturing device and the second glass manufacturing device.

In another aspect, the present invention provides a glass manufacturing system comprising: (a) a melting vessel within which glass batch materials are melted to form molten glass; (b) a melting to fining. tube which receives the molten glass from the melting vessel; (c) a fining vessel which receives the molten glass from the melting to fining tube and removes bubbles from the molten glass; (d) a finer to stir chamber tube which receives the molten glass from the fining vessel, the finer to stir chamber tube having a level probe standpipe attached thereto; (e) a stir chamber which receives the molten glass from the finer to stir chamber tube and mixes the molten glass; (f) a stir chamber to bowl connecting tube which receives the molten glass from the stir chamber; (g) a bowl which receives the molten glass from the stir chamber to bowl connecting tube; (h) a downcomer which receives the molten glass from the bowl; (i) a capsule located around the fining vessel, the finer to stir chamber tube, the level probe standpipe, the stir chamber, the stir chamber to bowl connecting tube, the bowl, at least a portion of the melting to fining tube, and at least a portion of the downcomer; (j) a fusion draw machine which includes an inlet, a forming vessel, and a pull roll assembly where: the inlet receives the molten glass from the downcomer; the forming apparatus receives the molten glass from the inlet and forms a glass sheet; and the pull roll assembly receives the glass sheet and draws the glass sheet; (k) a travelling anvil machine which receives the drawn glass sheet and separates the drawn glass sheet into separate glass sheets; and (1) a first fiber-based gasket placed in a connection between an opening of the capsule and an opening of the fusion draw machine where the downcomer interfaces with the inlet, wherein the first fiber-based gasket has a density and compression which results in a gas permeation rate per unit surface area that is less than 22.5 ml/min/cm² where the surface area is based on an inner gasket surface area.

In yet another aspect, the present invention includes a method for reducing thermal cell induced blistering in a glass manufacturing system. The glass manufacturing system comprises: (a) a melting vessel within which glass batch materials are melted to form molten glass; (b) a melting to fining tube which receives the molten glass from the melting vessel; (c) a fining vessel which receives the molten glass from the melting to fining tube and removes bubbles from the molten glass; (d) a finer to stir chamber tube which receives the molten glass from the fining vessel, the finer to stir chamber tube having a level probe standpipe attached thereto; (e) a stir chamber which receives the molten glass from the finer to stir chamber tube and mixes the molten glass; (f) a stir chamber to bowl connecting tube which receives the molten glass from the stir chamber; (g) a bowl which receives the molten glass from the stir chamber to bowl connecting tube; (h) a downcomer which receives the molten glass from the bowl; (i) a capsule located around the fining vessel, the finer to stir chamber tube, the level probe standpipe, the stir chamber, the stir chamber to bowl connecting tube, the bowl, at least a portion of the melting to fining tube, and at least a portion of the downcomer; (j) a fusion draw machine which includes an inlet, a forming vessel, and a pull roll assembly where: the inlet receives the molten glass from the downcomer; the forming apparatus receives the molten glass from the inlet and forms a glass sheet; and the pull roll assembly receives the glass sheet and draws the glass sheet; and (k) a travelling anvil machine which receives the drawn glass sheet and separates the drawn glass sheet into separate glass sheets. The method comprises the steps of: (a) placing a first fiber-based gasket in a connection between an opening of the capsule and an opening of the fusion draw machine where the downcomer interfaces with the inlet; and (b) compressing the first fiber-based gasket so the first fiber-based gasket has a gas permeation rate per unit surface area that is less than 22.5 ml/min/cm² where the surface area is based on an inner gasket surface area.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be had by reference to the following detailed description when taken in conjunction with the accompanying drawings wherein:

FIG. 1 is a schematic view of an exemplary glass manufacturing system which incorporates one or more fiber-based gaskets and uses a fusion draw process to manufacture a glass sheet in accordance with an embodiment of the present invention;

FIG. 2 is a detailed schematic view of the area associated with the first fiber-based gasket, a downcomer and an inlet of the glass manufacturing system shown in FIG. 1;

FIG. 3 is a plot of air permeation rate through the gasket per unit surface area (ml/min/cm²) versus gasket compression (%) for four exemplary fiber-based materials with different densities which can be used as the fiber-based gaskets of the glass manufacturing system shown in FIG. 1;

FIGS. 4A-4D are schematic diagrams and photos of a lab apparatus used to obtain data that was used to generate the plot shown in FIG. 3; and

FIG. 5 is a schematic view of a fiber-based gasket placed in a connection between a first glass manufacturing device and a second glass manufacturing device in accordance with an embodiment of the present invention.

### DETAILED DESCRIPTION

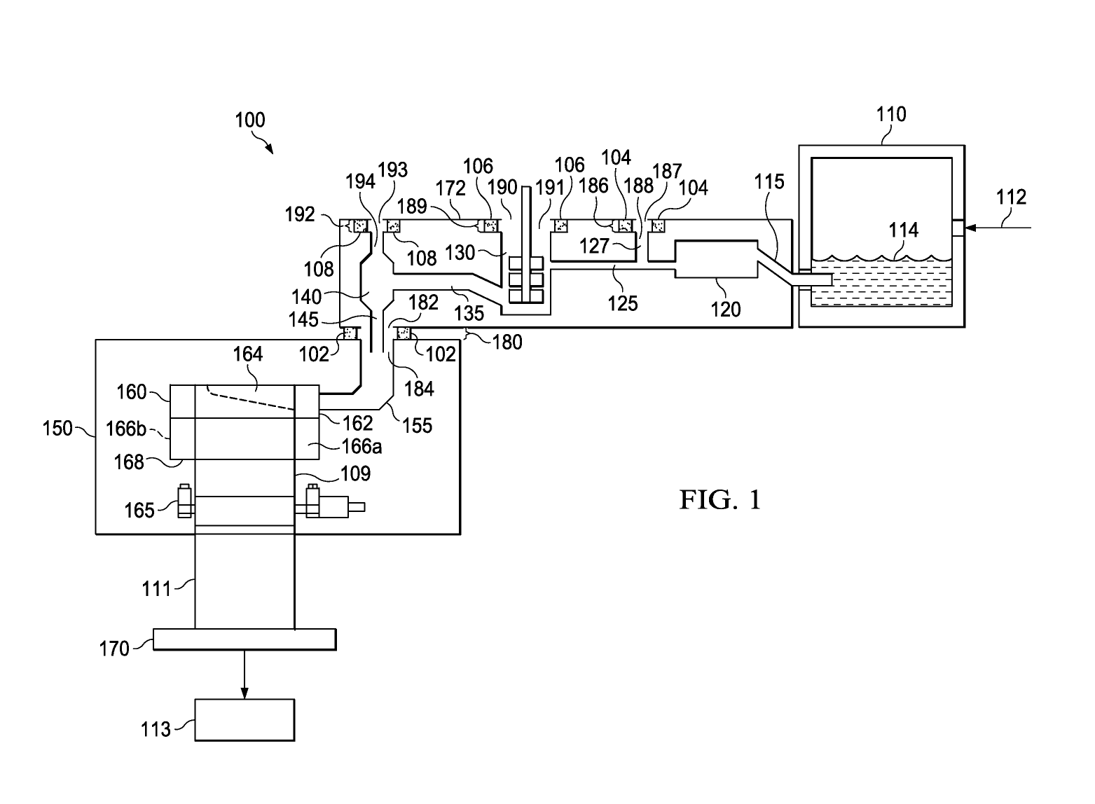

Referring to FIG. 1, there is shown a schematic view of an exemplary glass manufacturing system 100 which incorporates one or more fiber-based gaskets 102, 104, 106 and 108 (only four shown) and uses a fusion draw process to manufacture a glass sheet 113 in accordance with an embodiment of the present invention. The glass manufacturing system 100 includes a melting vessel 110, a melting to fining tube 115, a fining vessel 120, a finer to stir chamber tube 125 (with a level probe standpipe 127 extending therefrom), a stir chamber 130 (e.g., mixing vessel 130), a stir chamber to bowl connecting tube 135, a bowl 140 (e.g., delivery vessel 140), a downcomer 145, a fusion draw machine (FDM) 150 (which includes an inlet 155, a forming apparatus 160, and a pull roll assembly 165), and a traveling anvil machine (TAM) 170. In addition, the glass manufacturing system 100 includes a capsule 172 located around the fining vessel 120, the finer to stir chamber tube 125, the level probe standpipe 127, the stir chamber 130, the stir chamber to bowl connecting tube 135, the bowl 140, at least a portion of the melting to fining tube 115, and at least a portion of the downcomer 145. The capsule 172 is shown as a box shape but in practice would have a shape that more closely resembles and is physically located closer to the encapsulated components 115, 120, 125, 127, 130, 135, 140, and 145. Typically, the components 115, 120, 125, 127, 130, 135, 140, 145 and 155 are made from platinum or platinum-containing metals such as platinum-rhodium, platinum-iridium and combinations thereof, but they may also comprise other refractory metals such as palladium, rhenium, ruthenium, and osmium, or alloys thereof. The forming apparatus 160 (e.g., isopipe 160) is typically made from a ceramic material or glass-ceramic refractory material.

The melting vessel 110 is where glass batch materials are introduced as shown by arrow 112 and melted to form molten glass 114. The fining vessel 120 (e.g., finer tube 120) is connected to the melting vessel 110 by the melting to fining tube 115. The fining vessel 120 has a high temperature processing area that receives the molten glass 114 (not shown at this point) from the melting vessel 110 and in which bubbles are removed from the molten glass 114. The fining vessel 120 is connected to the stir chamber 130 by the finer to stir chamber connecting tube 125. The stir chamber 130 is connected to the bowl 140 by the stir chamber to bowl connecting tube 135. The bowl 140 delivers the molten glass 114 (not shown) through the downcomer 145 into the FDM 150.

The FDM 150 includes the inlet 155, the forming vessel 160 (e.g., isopipe 160), and the pull roll assembly 165. The inlet 155 receives the molten glass 114 (not shown) from the downcomer 145 and from the inlet 155 the molten glass 114 (not shown) then flows to the forming vessel 160. The forming vessel 160 includes an opening 162 that receives the molten glass 114 (not shown) which flows into a trough 164 and then overflows and runs down two opposing sides 166a and 166b before fusing together at a root 168 to form the glass sheet 109. The pull roll assembly 165 receives the glass sheet 109 and outputs a drawn glass sheet 111. The TAM 170 receives the drawn glass sheet 111 and separates the drawn glass sheet 111 into separate glass sheets 113.

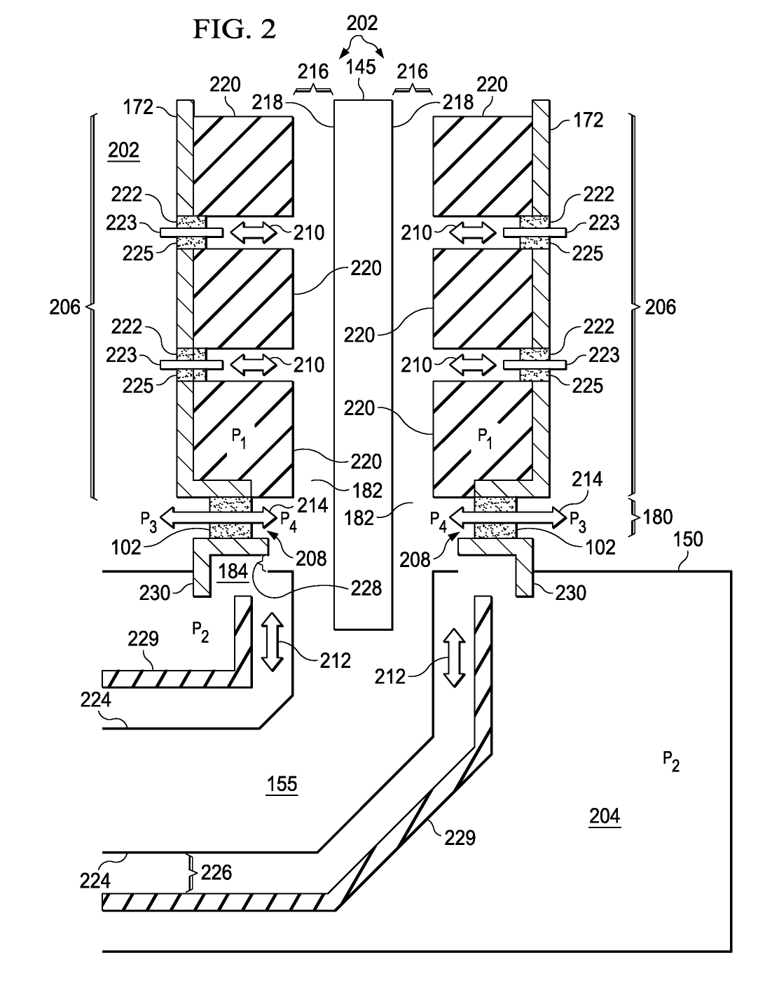

As discussed in the Background Section, the traditional glass manufacturing system (similar to the glass manufacturing system 100 except for the fiber-based gaskets 102, 104, 106 and 108) currently suffers from unacceptable levels of loss due to thermal cell induced blistering which is caused by the infiltration of ambient air between the connection(s) of glass manufacturing devices. The source of the oriented blisters was ultimately determined to be caused by an electrochemically induced cell from the impingement of ambient air on the exterior surface of the platinum delivery system, especially near the downcomer 145 and/or inlet 155. To address this problem, the glass manufacturing system 100 utilizes the fiber-based gasket 102 which is placed in a connection 180 between an opening 182 of the capsule 172 and an opening 184 of the FDM 150 in an area near where the downcomer 145 interfaces with the inlet 155 (note: the glass manufacturing system 100 can if desired utilize additional fiber-based gaskets 104, 106, 108 as discussed below). A detailed discussion about how this problem was detected in the traditional glass manufacturing system's downcomer 145 and inlet 155 and how this problem was solved by using the fiber-based gasket 102 is discussed next with respect to FIGS. 2-4.

Referring to FIG. 2, there is shown a detailed schematic view of the area associated with the downcomer 145 and inlet 155 of the glass manufacturing system 100 shown in FIG. 1. This schematic view which is not to scale is provided to illustrate the primary parts of the area associated with the downcomer 145 and inlet 155 including the fiber-based gasket 102 is placed in the connection 180 between the capsule 172 (located around the downcomer 145) and the FDM 150. The inlet 155 is surrounded by insulating refractory and AC heated windings 229 which are also located in the FDM 150. The area associated with the downcomer 145 and the inlet 155 has four separate zones 202, 204, 206 and 208 which should have atmospheric isolation either through sealing or pressure equalization to prevent the infiltration of gas (e.g., ambient air) which can then contact the exterior surfaces 218 and 224 of the downcomer 145 and the inlet 155. The four zones 202, 204, 206 and 208 respectively include the capsule 172 located around the downcomer 145, the internal atmosphere of the FDM 150 especially around the inlet 155, the ambient atmosphere surrounding the area associated with the downcomer 145 and the inlet 155 (i.e. the FDM 150), and the area internal to the fiber-based gasket 102. In practice, these four zones 202, 204, 206 and 208 are not perfectly sealed and can have four different pressures including a capsule pressure P₁, a FDM pressure P₂, a FDM enclosure/ambient pressure P₃, and a pressure P₄ internal to the fiber-based gasket 102. The pressures P₁, P₂ and P₃ can be measured while pressure P₄ is not measured but is some average of pressures P₁, P₂, and P₃.

As shown, gas (e.g., ambient air) can leak in these four zones 202, 204, 206 and 208 through several paths 210, 212 and 214. In particular, gas (capsule atmosphere) can leak through the thermocouple holes 222 via path 210 into a gap 216 between the external surface 218 of the downcomer 145 and refractory insulation and winding 220. Once inside this gap 216, the gas can move around the exterior surface 218 of the downcomer 145. If desired, the open space in the thermocouple holes 222 located between the thermocouples 223 and the capsule 172 can be sealed with compressed fiber material 225 (fiber-based gasket 225) which is similar or the same as the material used in the fiber-based gasket 102. The second path 212 for gas to leak is inside the FDM 150 around an exterior surface 224 of the inlet 155. In one example, the gap 216 between the downcomer 145 and the refractory insulation and winding 220 is approximately ¼″ while there is a ⅛″ gap 226 between the inlet 155 and the insulating refractory and AC heated windings 229 and a 1/16″ gap 228 between the inlet 155 and a spacer ring block 230. In practice, these components can be made to fairly large tolerances so these gaps 216, 226 and 228 could be significantly bigger. Thus, gas (atmosphere) can potentially leak via paths 210 and 212 to contact the downcomer 145 and the inlet 155. However, the third path 214 where gas can leak through the fiber-based gasket 102 is more problematic when compared to paths 210 and 212 and is one of the problems addressed in this document.

The fiber-based gasket 102 is shown located in the connection 180 between the downcomer's capsule 172 and the FDM's spacer ring block 230. In the past, the traditional glass manufacturing system used a fiber-based gasket in this connection which was made of a material manufactured by Unifrax I LLC and sold under the brand name of Fiberfrax Durablanket “S” (see below TABLES 1 and 2). The traditional fiber-based gasket made from Fiberfrax Durablanket ‘S’ has fibers with diameters in range of 2.5-3.5 μm, an uncompressed material density of 6 lb/ft³ as supplied by the manufacturer, and was compressed to about 50% compression, where compression is defined herein as the percentage by which the fiber-based gasket decreased in volume from its original volume as supplied by the manufacturer. However, process evidence suggested that the traditional fiber-based gasket was highly porous and allowed significant air permeation there through even at pressure differentials lower than 0.01 inches of water (2.5 pascals). This air permeation resulted in a significant infiltration of ambient air and the flow of gas to occur around and cool the downcomer 145 and the inlet 155 which resulted in unacceptable levels of loss due to thermal cell induced blistering.

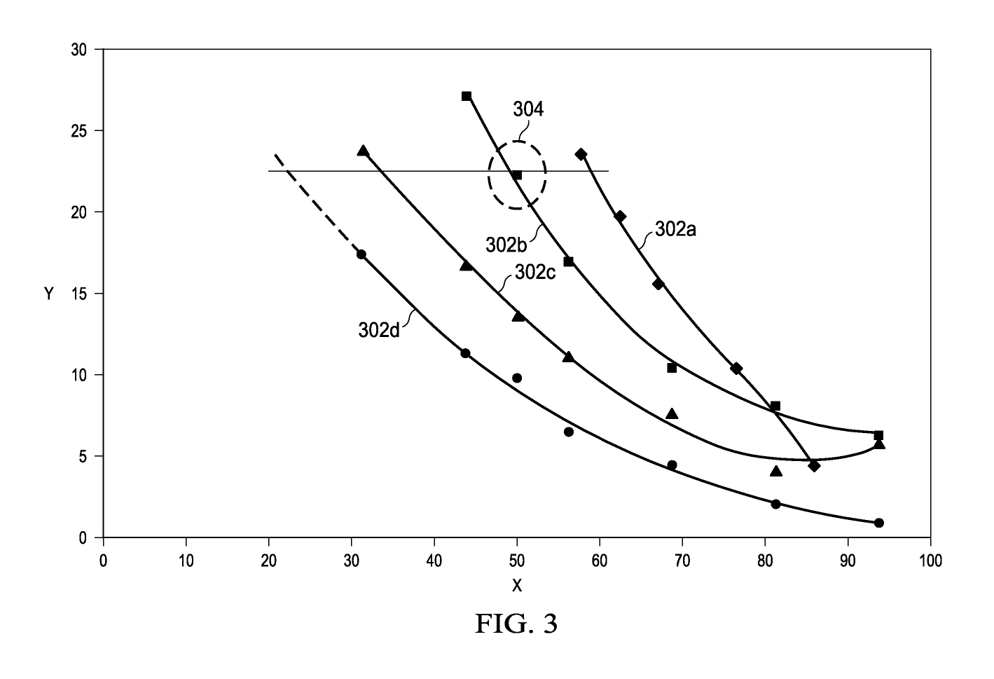

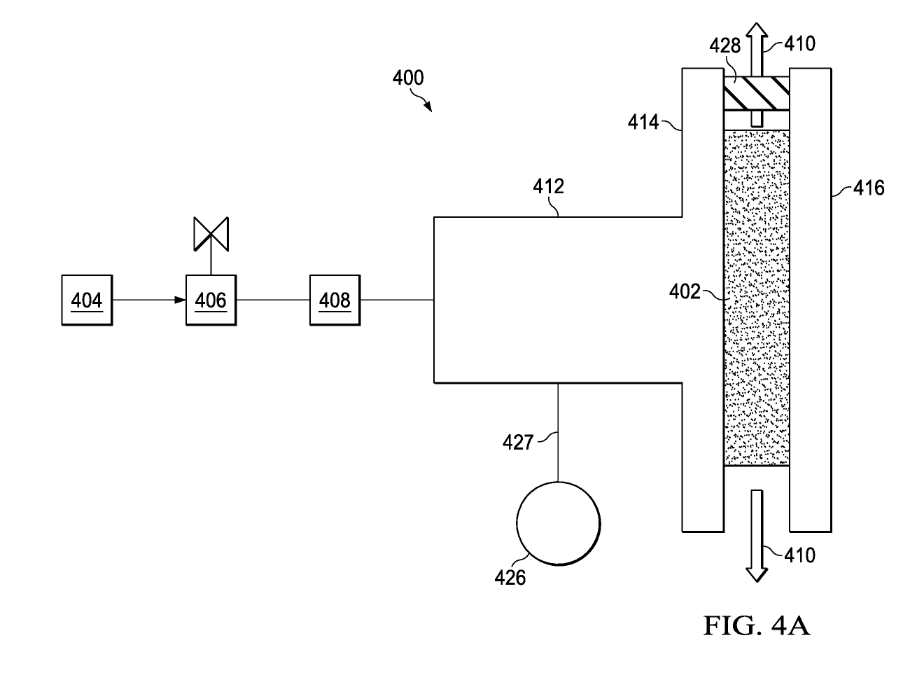

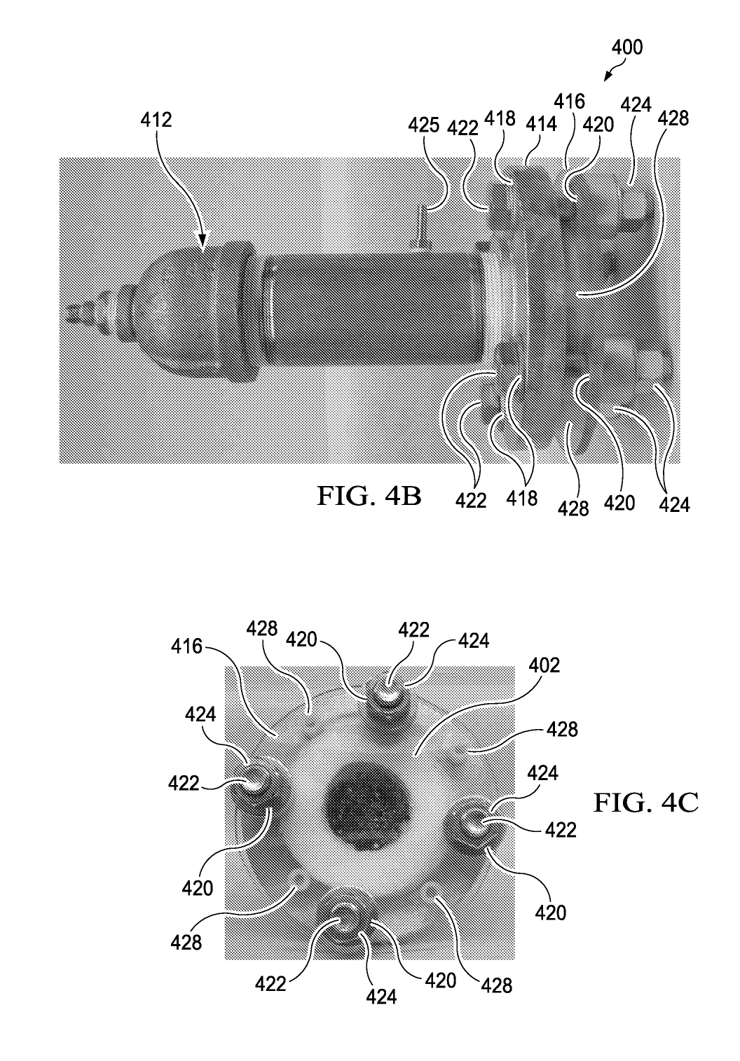

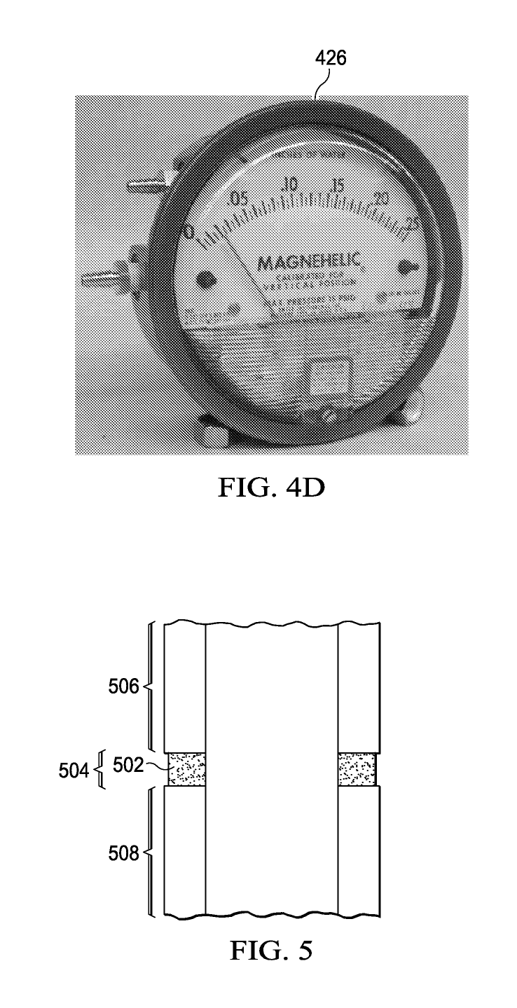

Furthermore, the process evidence indicated that the level of thermal cell induced blisters could be reduced or totally eliminated by controlling the infiltration of ambient air into the area associated with the downcomer 145 and the inlet 155. The present invention accomplishes this by increasing the compression on the gasket 102 between the downcomer 145 and the inlet 155 and/or increasing the density of the gasket 102 (before compression). In a sense, it was discovered that if the fiber gasket 102 had the proper density and/or level of compression then it could act as a seal or barrier to gas infiltration and thus address one of the main contributors for thermal cell blister generation. In particular, it was discovered that if the fiber gasket 102 had a density and compression which results in a gas permeation rate per unit surface area that is less than 22.5 ml/min/cm² where the surface area is based on an inner gasket surface area then this would address one of the main contributors for thermal cell blister generation. How this was discovered is discussed below with respect to FIGS. 3-4.

Referring to FIG. 3, there is a plot of air permeation rate through gasket per unit surface area (ml/min/cm²) versus gasket compression (%) with a 5 pascal pressure differential and variable air flowrate for four exemplary fiber-based materials 302a, 302b, 302c, and 302d with different densities. The air permeation rate is represented on the y-axis and the gasket compression is represented in the x-axis. The four exemplary fiber-based materials 302a, 302b, 302c, and 302d which had a 4 inch outer diameter and 2 inch inner diameter are as follows:
(1) fiber-based material 302a (density of 2.2 lb/ft³—brand name RSMAT-3000).
(2) fiber-based material 302b (density of 6 lb/ft³—brand name Durablanket “S”).
(3) fiber-based material 302c (density of 8 lb/ft³—brand name Durablanket “S”).
(4) fiber-based material 302d (density of 9.5 lb/ft³—brand name SB-2000).

Note: The densities of the fiber-based materials 302a, 302b, 302c and 302d listed above are the densities of the materials as supplied by the manufacturers before compression.

The gasket material currently used to seal the connection 180 between the downcomer 145 and the inlet 155 is Durablanket ‘S’ in 6 lb/ft³ at 50% compression with flowing air at 456 ml/min resulted in an undesirable air permeation rate of 22.5 ml/min/cm² (see circle 304 in FIG. 3). Hence, the fiber gasket 102 of the present invention can include any fiber-based material with a combination of density and compression that results in an air permeation rate that is less than 22.5 ml/min/cm² where the surface area is based on an inner gasket surface area. As a result, the fiber gasket 102 can include many combinations of fiber-based material densities and compressions which have an air permeation rate that is less than 22.5 ml/min/cm². The higher levels of compression and/or the higher density fiber-based material are favorable for limiting the flow of gas through the fiber gasket 102, and are also favorable conditions for reducing convective heat transfer and thermal cell blisters on the downcomer 145 and the inlet 155.

TABLES 1 and 2 list the properties and compositions of the four exemplary gasket materials 302a, 302b, 302c, and 302d that were used in experiments to generate the data represented in the plot of FIG. 3.

TABLE # 1

| | | Nominal | Maximum |
|---|---|---|---|
| | | Material | Use |
| Gasket | | Density* | Temperature |
| Material | Supplier (Brandname) | (lb/ft³) | (° C.) |
| Fiber-based | Zircar Refractory Composites, | 2.2 | 1650 |
| material 302a | Inc. (RSMAT-3000) | | |
| Fiber-based | Unifrax Corporation | 6 | 1260 |
| material 302b | (Durablanket “S”) | | |
| Fiber-based | Unifrax Corporation | 8 | 1260 |
| material 302c | (Durablanket “S”) | | |
| Fiber-based | Zircar Refractory Composites, | 9-10 | 1100 |
| material 302d | Inc. (SB-2000) | | |

*The “nominal material density” means the material density as it is supplied by the manufacturer before compression. The term “compression” is defined herein as the percentage by which the fiber-based gasket is decreased in volume from its original volume as supplied by the manufacturer.

TABLE #2

| Material | | SiO2 | Al2O3 | MgO | Na2O3 | CaO | TiO2 |
|---|---|---|---|---|---|---|---|
| Name | Manufacturer | (wt %) | (wt %) | (wt %) | (wt %) | (wt %) | (wt %) |
| Fiber-based | Zircar | 3 | 97 | | 0.0875 | 0.0525 | |
| material 302a | Refractory | | | | | | |
| | Composites | | | | | | |
| | Incorporated | | | | | | |
| Fiber-based | Unifrax | 53-57 | 43-47 | | <0.5 | | trace |
| materials 302b | Corporation | | | | | | |
| and 302c | | | | | | | |
| Fiber-based | Zircar | 97.85 | 0.71 | 0.17 | | 0.23 | 0.8 |
| material 302d | Refractory | | | | | | |
| | Composites | | | | | | |
| | Incorporated | | | | | | |

| | | | | Leachable | Other | Other | Trace | Fiber |
|---|---|---|---|---|---|---|---|---|
| Material | B2O3 | Fe2O3 | Alkali | Chlorides | Inorganics | Oxides | Elements | Diameter |
| Name | (wt %) | (wt %) | (wt %) | (ppm) | (wt %) | (wt %) | (wt %) | (um) |
| Fiber- | | | | | | | <0.5 | 3.0-5.0 |
| based | | | | | | | | |
| material | | | | | | | | |
| 302a | | | | | | | | |
| Fiber- | | trace | 0.05 | <10 | 0.85 | | | 2.5-3.5 |
| based | | | | | | | | |
| materials | | | | | | | | |
| 302b | | | | | | | | |
| and 302c | | | | | | | | |
| Fiber- | 0.16 | | | | | <0.08 | | 6.0-9.0 |
| based | | | | | | | | |
| material | | | | | | | | |
| 302d | | | | | | | | |

The scenario described above discussed several different materials and method improvements for sealing the connection 180 in the area near the downcomer 145 and the inlet 150. There are other areas in the glass manufacturing system 100 that could utilize the same type of fiber-based gasket 102 such as the fiber-based gaskets 104, 106, 108 and 225 to act as a seal or barrier to gas infiltration and reduce the level of loss due to thermal cell induced blistering. In this regard, the glass manufacturing system 100 can include one or more of the following: (1) the second fiber-based gasket 104 placed in a connection 186 between an opening 187 of the capsule 172 and an opening 188 of the level probe standpipe 127; (2) the third fiber-based gasket 106 placed in a connection 189 between an opening 190 of the capsule 172 and an opening 191 at a top of the stir chamber 130; and (3) the fourth fiber-based gasket 108 placed in a connection 192 between an opening 193 of the capsule 172 and an opening 194 at a top of the bowl 140. Likewise, the glass manufacturing system 100 may use fiber-based gaskets 225 like the ones shown in FIG. 2 which seal thermocouple holes 222 in the capsule 172 in other locations in the capsule 172 as well where holes are present or created to accommodate sensors or other devices. The fiber-based gaskets 104, 106, 108 and 225 each have a density and compression which results in a gas permeation rate per unit surface area that is less than 22.5 ml/min/cm² where the surface area is based on an inner gasket surface area.

The fiber-based gaskets 102, 104, 106, 108 and 225 can have many different fiber-based material compositions, fiber diameters, ratios of fibers to unfiberized material, material densities, and material compressions which can result in a gas permeation rate per unit surface area that is less than 22.5 ml/min/cm² that can work well in the glass manufacturing system 100. The following is an exemplary list of material properties and characteristics that could be associated with the fiber-based gaskets 102, 104, 106, 108 and 225:

1. The fiber-based gaskets 102, 104, 106, 108 and 225 comprise a fiber-based material.

2. The fiber-based gaskets 102, 104, 106, 108 and 225 comprise fibers containing 0-100% silica, 0-100% alumina, 0-100% zirconia, and various concentrations of other oxides.

3. The fiber-based gaskets 102, 104, 106, 108 and 225 comprise fibers with diameters greater than 0.5 um.

4. The fiber-based gaskets 102, 104, 106, 108 and 225 have a maximum use temperature greater than 500° C.

5. The fiber-based gaskets 102, 104, 106, 108 and 225 have a fiber index >20%. Fiber index is the percentage (by weight) of fiberized material compared to the total material weight including shot or unfiberized material*.

*Most fiber-based materials contain some level of unfiberized material also called shot. The unfiberized material is a byproduct of the fiber manufacturing process. Manufacturers such as Unifrax refer to their materials as being made of fibers even if their materials contain some amount of unfiberized material. Fiber-based materials typically contain only a small percentage of shot, but the shot content can still be rather high.

6. The fiber-based gaskets 102, 104, 106, 108 and 225 may or may not contain an organic or inorganic binder.

Referring to FIGS. 4A-4D, there is a schematic diagram and photos of a lab apparatus 400 used to obtain data that was used to generate the data for the plot shown in FIG. 3. The lab apparatus 400 was used to simulate air permeation through an exemplary fiber-based gasket 402 (e.g., fiber-based materials 302a, 302b, 302c, and 302d). As shown, the lab apparatus 400 includes a compressed air cylinder 404 which supplies air through a metering valve 406 and a flowmeter 408 which were used to control and measure the air permeation rate through the fiber-based gasket 402 (see path 410). After passing through the flowmeter 408, the air entered a pressure vessel 412 which has a threaded flange 414 and a blind flange 416 (see FIG. 4B). The threaded flange 414 had four holes 418 (three shown) (see FIG. 4B). The blind flange 416 had four holes 420 and was blind meaning it served as a plug (see FIG. 4C). The two flanges 414 and 416 were connected by four bolts 422 and four nuts 424. This configuration forced all the air flowing through the flowmeter 408 to permeate through the fiber-based gasket 402 via path 410. A pressure gauge 426 was also connected via tubing 427 to a port 425 on the pressure vessel 412 (see FIGS. 4B and 4D).

The following procedure was used to test each gasket material 302a, 302b, 302c, and 302d. The gasket material 302a (for example) was cut into a donut shape to form the gasket 402 using a core drill for both the inner diameter (e.g. two inch inner diameter) and the outer diameter (e.g., four inch outer diameter). The gasket 402 was then placed between the two flanges 414 and 416 and the flange bolts 422 were tightened to an initial gap. This gap was set by placing several spacers 428 between the two flanges 414 and 416 (see FIGS. 4A-4C). The spacers 428 were used to set the compression of the fiber-based gasket 402. Air was then flowed through the flowmeter 408 by adjusting the metering valve 406 until the pressure gauge 426 read the desired pressure upstream of the fiber-based gasket 402. Several air permeation rate/vessel pressure measurement combinations were taken, where the air permeation rate through the fiber-based gasket 402 was equal to the air flowrate through the flowmeter 408. These measurements were possible because the lab apparatus 400 had leak tight connections such that air could only escape through the fiber-based gasket 402.

The relationship between air permeation rate and gasket compression was obtained by adjusting the length of the spacers 428 and the gas flowrate through the metering valve 406. The pressure gauge 426 measured the pressure inside the pressure vessel 412 upstream of the fiber-based gasket 402. This pressure measurement gave a pressure differential over the fiber-based gasket 402 (note: the data points in FIG. 3 were obtained at a 5 pascal pressure differential). The gap between the two flanges 414 and 416 was then reduced by removing the spacers 428, adding smaller spacers 428, and tightening the bolts 422. The procedure described above was repeated for several different sized gaps. This setup and procedure provided a range of air permeation rates at a constant vessel pressure over a range of gasket compressions for several different materials. Data generated with this lab apparatus 400 was used to determine the proper density and compression for the fiber-based gasket 102 associated with the downcomer 145 and inlet 155.

Referring to FIG. 5, there is shown a schematic view of a fiber-based gasket 502 placed in a connection 504 between a first glass manufacturing device 506 and a second glass manufacturing device 508 in accordance with an embodiment of the present invention. The fiber-based gasket 502 has a density and compression which results in a gas permeation rate per unit surface area that is less than 22.5 ml/min/cm² to reduce thermal cell induced blistering within the first glass manufacturing device and the second glass manufacturing device. Hence, the fiber-based gasket of the present invention can be used in any type of glass melting system and not just the glass manufacturing system 100 described above with respect to FIG. 1.

From the foregoing, one skilled in the art will appreciate that present invention relates to the fiber-based gasket 102, 104, 106, 108 and 225 which has an optimized density and/or compression for use in a glass melting system. The fiber-based gasket 102, 104, 106, 108 and 225 with the optimized gasket material or increased gasket material compression reduces air movement near one or more glass melting devices which reduces convective heat transfer on the surfaces of the one or more glass melting devices. This ultimately reduces the thermal gradient on the surfaces of the one or more glass melting devices and thus lowers the occurrence of thermal cell induced blisters. The fiber-based gasket 102, 104, 106, 108 and 225 has several advantages some of which are as follows:
Reduces gas impingement and convective heat transfer on the platinum surfaces of the downcomer 145 and inlet 155.
Prevents hydrogen permeation blistering due to low dew point ambient air coming in contact with the external surfaces of the glass melting system.
Reduces thermal cell blisters on the platinum surfaces of the downcomer 145 and inlet 155. This ultimately leads to less loss of glass and better glass selection rates in production.
The material cost and time to retrofit existing glass manufacturing systems to incorporate one or more fiber-based gaskets 102, 104, 106, 108 and 225 is rather small when compared to the savings in glass loss by the presence of the fiber-based gaskets.

Although several embodiments of the present invention have been illustrated in the accompanying Drawings and described in the foregoing Detailed Description, it should be understood that the invention is not limited to the disclosed embodiments, but is capable of numerous rearrangements, modifications and substitutions without departing from the invention as set forth and defined by the following claims.

1. A fiber-based gasket placed in a connection between a first glass manufacturing device and a second glass manufacturing device, the fiber-based gasket comprising:
a fiber-based material having a density and compression which results in a gas permeation rate per unit surface area that is less than 22.5 ml/min/cm² where the surface area is based on an inner gasket surface area, wherein the fiber-based material reduces thermal cell induced blistering within the first glass manufacturing device and the second glass manufacturing device.

2. The fiber-based gasket of claim 1, wherein the fiber-based material includes fibers containing 0-100% silica, 0-100% alumina, 0-100% zirconia, and various concentrations of other oxides.

3. The fiber-based gasket of claim 1, wherein the fiber-based material has a maximum use temperature greater than 500° C.

4. The fiber-based gasket of claim 1, wherein the fiber-based material has a fiber index >20%, where the fiber index is a percentage of fiberized material weight compared to a total material weight including unfiberized material.

5. The fiber-based gasket of claim 1, wherein the fiber-based material includes fiber with a diameter greater than 0.5 μm.

6. A glass manufacturing system comprising:
a melting vessel within which glass batch materials are melted to form molten glass;
a melting to fining tube which receives the molten glass from the melting vessel;
a fining vessel which receives the molten glass from the melting to fining tube and removes bubbles from the molten glass;
a finer to stir chamber tube which receives the molten glass from the fining vessel, the finer to stir chamber tube having a level probe standpipe attached thereto;
a stir chamber which receives the molten glass from the finer to stir chamber tube and mixes the molten glass;
a stir chamber to bowl connecting tube which receives the molten glass from the stir chamber;
a bowl which receives the molten glass from the stir chamber to bowl connecting tube;
a downcomer which receives the molten glass from the bowl;
a capsule located around the fining vessel, the finer to stir chamber tube, the level probe standpipe, the stir chamber, the stir chamber to bowl connecting tube, the bowl, at least a portion of the melting to fining tube, and at least a portion of the downcomer;
a fusion draw machine which includes an inlet, a forming vessel, and a pull roll assembly wherein:
the inlet receives the molten glass from the downcomer;
the forming apparatus receives the molten glass from the inlet and forms a glass sheet; and
the pull roll assembly receives the glass sheet and draws the glass sheet;
a travelling anvil machine which receives the drawn glass sheet and separates the drawn glass sheet into separate glass sheets;
a first fiber-based gasket placed in a connection between an opening of the capsule and an opening of the fusion draw machine where the downcomer interfaces with the inlet, wherein the first fiber-based gasket has a density and compression which results in a gas permeation rate per unit surface area that is less than 22.5 ml/min/cm² where the surface area is based on an inner gasket surface area.

7. The glass manufacturing system of claim 6, wherein the first fiber-based gasket includes fibers containing 0-100% silica, 0-100% alumina, 0-100% zirconia, and various concentrations of other oxides.

8. The glass manufacturing system of claim 6, wherein the first fiber-based gasket has a maximum use temperature greater than 500° C.

9. The glass manufacturing system of claim 6, wherein the first fiber-based gasket has a fiber index >20%, where the fiber index is a percentage of fiberized material weight compared to a total material weight including unfiberized material.

10. The glass manufacturing system of claim 6, wherein the first fiber-based material includes fiber with a diameter greater than 0.5 μm.

11. The glass manufacturing system of claim 6, further comprising a second fiber-based gasket placed in a connection between an opening of the capsule and an opening of the level probe standpipe, wherein the second fiber-based gasket has a density and compression which results in a gas permeation rate per unit surface area that is less than 22.5 ml/min/cm² where the surface area is based on an inner gasket surface area.

12. The glass manufacturing system of claim 6, further comprising a third fiber-based gasket placed in a connection between an opening of the capsule and an opening at a top of the stir chamber, wherein the third fiber-based gasket has a density and compression which results in a gas permeation rate per unit surface area that is less than 22.5 ml/min/cm² where the surface area is based on an inner gasket surface area.

13. The glass manufacturing system of claim 6, further comprising a fourth fiber-based gasket placed in a connection between an opening of the capsule and an opening at a top of the bowl, wherein the fourth fiber-based gasket has a density and compression which results in a gas permeation rate per unit surface area that is less than 22.5 ml/min/cm² where the surface area is based on an inner gasket surface area.

14. The glass manufacturing system of claim 6, further comprising a fifth fiber-based gasket placed in a hole within the capsule.

15. A method for reducing thermal cell induced blistering in a glass manufacturing system comprising:
a melting vessel within which glass batch materials are melted to form molten glass;
a melting to fining tube which receives the molten glass from the melting vessel;
a fining vessel which receives the molten glass from the melting to fining tube and removes bubbles from the molten glass;
a finer to stir chamber tube which receives the molten glass from the fining vessel, the finer to stir chamber tube having a level probe standpipe attached thereto;
a stir chamber which receives the molten glass from the finer to stir chamber tube and mixes the molten glass;
a stir chamber to bowl connecting tube which receives the molten glass from the stir chamber;
a bowl which receives the molten glass from the stir chamber to bowl connecting tube;
a downcomer which receives the molten glass from the bowl;
a capsule located around the fining vessel, the finer to stir chamber tube, the level probe standpipe, the stir chamber, the stir chamber to bowl connecting tube, the bowl, at least a portion of the melting to fining tube, and at least a portion of the downcomer;
a fusion draw machine which includes an inlet, a forming vessel, and a pull roll assembly wherein:
the inlet receives the molten glass from the downcomer;
the forming apparatus receives the molten glass from the inlet and forms a glass sheet; and
the pull roll assembly receives the glass sheet and draws the glass sheet;
a travelling anvil machine which receives the drawn glass sheet and separates the drawn glass sheet into separate glass sheets;
the method comprising the steps of:
placing a first fiber-based gasket in a connection between an opening of the capsule and an opening of the fusion draw machine where the downcomer interfaces with the inlet; and
compressing the first fiber-based gasket so the first fiber-based gaskets has a gas permeation rate per unit surface area that is less than 22.5 ml/min/cm² where the surface area is based on an inner gasket surface area.

16. The method of claim 15, wherein the first fiber-based gasket includes fibers containing 0-100% silica, 0-100% alumina, 0-100% zirconia, and various concentrations of other oxides.

17. The method of claim 15, wherein the first fiber-based gasket has a maximum use temperature greater than 500° C.

18. The method of claim 15, wherein the first fiber-based gasket has a fiber index >20%, where the fiber index is a percentage of fiberized material weight compared to a total material weight including unfiberized material.

19. The method of claim 15, wherein the first fiber-based material includes fiber with a diameter greater than 0.5 μm.

20. The method of claim 15, further comprising the steps of:
placing a second fiber-based gasket placed in a connection between an opening of the capsule and an opening of the level probe standpipe; and
compressing the second fiber-based gasket so the second fiber-based gaskets has a gas permeation rate per unit surface area that is less than 22.5 ml/min/cm² where the surface area is based on an inner gasket surface area.

21. The method of claim 15, further comprising the steps of:
placing a third fiber-based gasket placed in a connection between an opening of the capsule and an opening at a top of the stir chamber; and
compressing the third fiber-based gasket so the third fiber-based gaskets has a gas permeation rate per unit surface area that is less than 22.5 ml/min/cm² where the surface area is based on an inner gasket surface area.

22. The method of claim 15, further comprising the steps of:
placing a fourth fiber-based gasket placed in a connection between an opening of the capsule and an opening at a top of the bowl; and
compressing the fourth fiber-based gasket so the fourth fiber-based gaskets has a gas permeation rate per unit surface area that is less than 22.5 ml/min/cm² where the surface area is based on an inner gasket surface area.

23. The method of claim 15, further comprising the steps of:
placing a fifth fiber-based gasket placed in a hole in the capsule; and
compressing the fifth fiber-based gasket so the fifth fiber-based gaskets has a gas permeation rate per unit surface area that is less than 22.5 ml/min/cm² where the surface area is based on an inner gasket surface area.
